(19) United States
(12) Patent Application Publication
(10) Pub. No.: US 2012/0138767 A1
(43) Pub. Date: Jun. 7, 2012

(54) METHOD OF PRECISELY SUPPORTING A COMPONENT, PARTICULARLY AN OPTICAL COMPONENT

(76) Inventors: Christian Chappuis, Andernos Les Batns (FR); Francois Macias, Mios (FR)

(21) Appl. No.: 13/319,747

(22) PCT Filed: May 12, 2010
(86) PCT No.: PCT/EP10/56534

§ 371 Date: Feb. 22, 2012

(30) Foreign Application Priority Data
May 14, 2009 (FR) 09 53199

(51) Int. Cl. G02B 7/198

(52) U.S. Cl. 248/479

(57) ABSTRACT

An optical component (12) such as a mirror is supported by a device (17) comprising two levers (3, 4) for example articulated by flexible strips (9) such that their centre lines (13, 14) intersect at a point (15) defining a pivot and located beyond the end (2) of the device (17), at mid-depth of the component (12), the weight of which is vertically in line with this point (15), does not cause deformation of the component.

The subject of this invention is an assembly for precise support of a component, particularly an optical component.

Support at a precise position is important for optical components such as mirrors, for which the smallest rotation or deformation can affect the instrument to which they belong; but it is difficult to achieve simply for large thin optical components, because deformations due to the self weight of the component can play an important role when the component is placed vertically. Deformations due to thermal causes also have an important effect on the quality of many support devices. Finally, the use of components with a non-circular section makes the use of some assemblies complicated.

The optical component may be fixed in a frame by its edge, or it may be fixed at its back face. Some means comprise embedment in an elastomer seal or in flexible glue, fixing by rigid gluing, rigid gluing combined with elastic support strips, or clamps at three or four points. Some of these assemblies are flexible and they then have the disadvantage that they are imprecise because they are not sufficiently rigid and stable; other assemblies are rigid attachments, guaranteeing precise position of the component, but they have the disadvantage that they transmit large forces originating particularly from differential thermal expansions between the component and its support. And some are difficult to apply to large rectangular components.

There are also statically determinate support systems composed of articulated arms or more generally elastic deformable parts that have the general advantage of maintaining the component at a precise stable position without transmitting high stresses to it under differential thermal deformations. Good integration of the component, in compact form, is also possible due to these systems. However, these statically determinate supporting systems are difficult to install on thin non-circular components when bearing on the edge of the component. It is then necessary to consider statically determinate supports through the back of the component, but existing systems have the disadvantage of being sensitive to deformations due to the self-weight of the component and are affected by deformations that distort the position or the orientation of the component.

The subject of the invention is an assembly that uses at least one statically determinate support device for a component placed vertically, that does not have this latter disadvantage.

In a general form, the invention relates to an assembly comprising a support, a component and particularly an optical component, and at least one supporting device comprising a base, an end, two levers extending between the base the end forming an angle with each other and converging towards the end, the levers being articulated at the base and at the end so as to be free in rotation in a plane in which they both extend, the component being fixed to the end of the device and the base being fixed on the support, characterised in that a point at which the lever centre lines intersect is in the same vertical plane as the centre of gravity of the component and is at a median depth of the component, the plane in which the levers of the device extend also being vertical.

Such devices with two convergent levers have already been used to support mirrors (FR-A-2 773 890, EP-A-1 962 124, DE-A-44 26 160 and FR-A-2 770 308 for example), but the positions of the points at which the levers act are significantly outside the median plane of the mirror which is also placed horizontally in all these prior embodiments.

The intersection point of the lever axes defines a virtual rotation pivot of the optical component that will be fixed to the end of the device. It is close to median line of the component, in which its centre of gravity is located. The overhang between the virtual pivot and the application point of the weight of the component is zero or small, such that deformations of the support device due to the self weight of the component do not cause a large deformation of the component.

In one simple and advantageous design, the levers are articulated at the support and at the end by elastic strips.

The statically determinate nature of the assembly may be reinforced if the levers are also articulated at the base and at the end so as to be free in rotation perpendicular to the plane defined above.

In one important embodiment, the levers are articulated at the base and at the end by pairs of elastic strips arranged in series along the levers, each of the pairs comprising a strip oriented in said plane and a strip perpendicular to said plane.

Another assembly conforming with the invention also comprises a support, a component and particularly an optical component and at least two devices each conforming with the above, the component being fixed to the end of each device and the base of each device being fixed to the support, characterised in that for each of the devices, the point at which the axes of the levers intersect is in the same vertical plane close to the centre of the gravity of the component, a vertical line originating from the centre of gravity passing between said points at which the axes of the levers intersect. In this case, the devices must be placed symmetrically relative to the vertical line.

In all cases, static determinacy of the assembly is well respected if the component is fixed to the support by three devices, in which either each of the devices prevents translation of the component in two directions, or one prevents translation in one direction, one prevents translation in two directions and the third prevents translation in three directions.

In one particular embodiment of this statically determinate assembly, the three devices fixing the component to the support all include articulated levers at a base fixed in the support and at an end fixed to the component.

The invention will now be described with reference to the following figures:

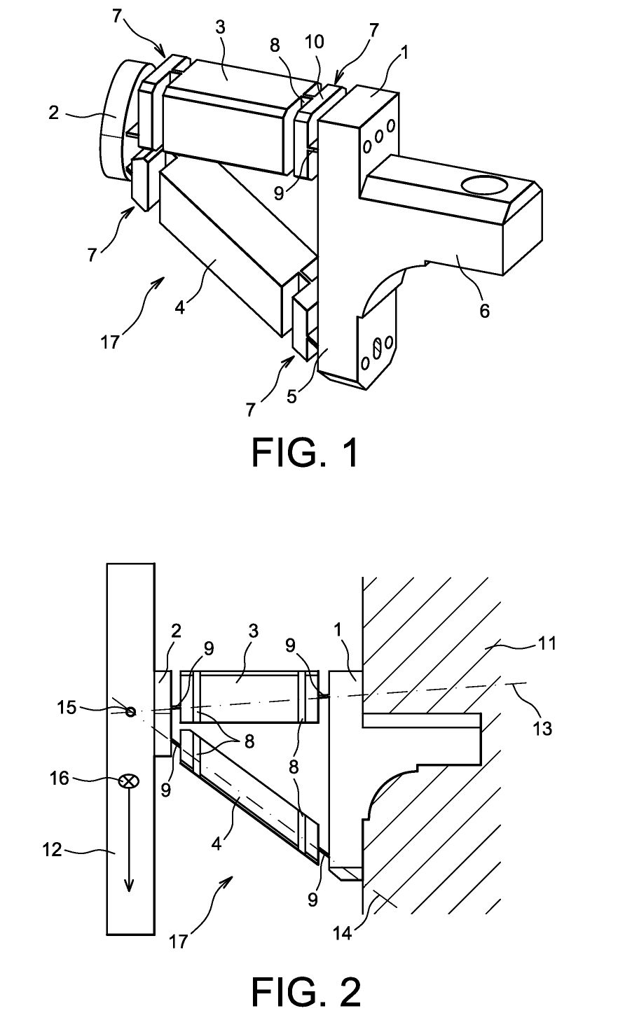

FIGS. 1 and 2 show a support device used in the invention,

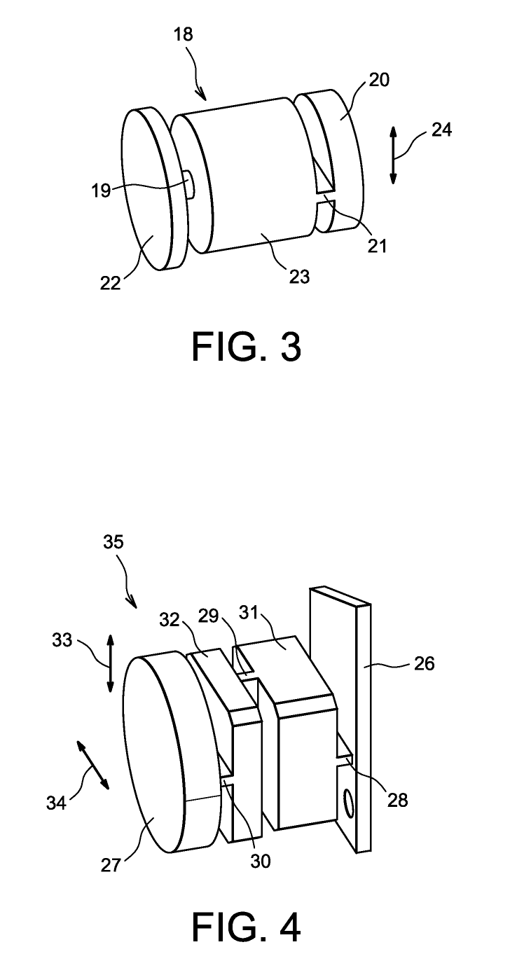

FIGS. 3 and 4 show two other support devices,

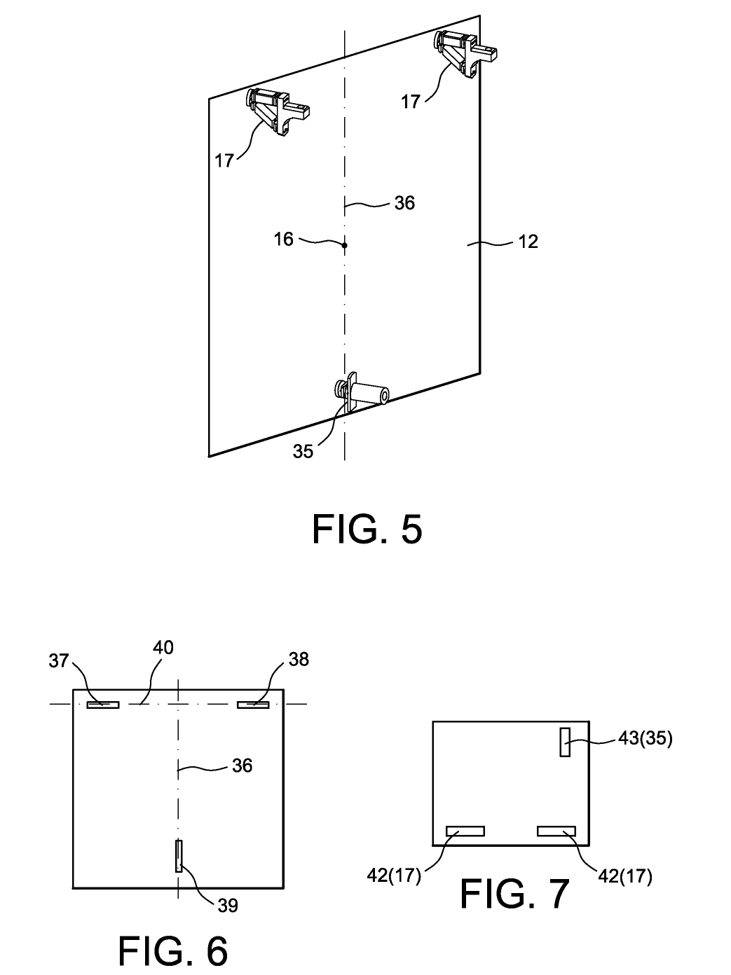

FIG. 5 shows an assembly conforming with the invention,

FIG. 6 is a functional diagram of the assembly in FIG. 5,

and FIGS. 7, 8, 9, 10, 11, 12 and 13 are functional diagram of other assemblies.

One important embodiment of a support device 17 used in the invention is shown in FIG. 1. It comprises a base 1, and end 2, and an upper lever 3 and a lower lever 4 each extending between the base 1 and the end 2. The upper lever 3 and the lower lever 4 are in a common plane that will be called vertical with reference to its most typical position when the device is in service. It forms an acute angle that converges towards the end 2. The base 1 is composed of a principal portion 5 that is vertical to which the ends of the levers 3 and 4 are fixed, and a posterior projection 6 (opposite the levers 3 and 4 relative to the principal portion 5) that will be embedded in a fixed structure. Each of the levers 3 and 4 is articulated to the principal portion 5 by an articulation 7 composed of a vertical strip 8 attached to the levers 3 or 4, a horizontal strip 9 attached to the principal portion 5 and a junction 10 joining the strips 8 and 9; the articulations allow rotation movements of the levers 3 and 4 in the vertical direction and in the horizontal direction due to the flexibility of the strips 9 and 8 and therefore form articulations with two degrees of freedom of rotation. The levers 3 and 4 are connected to the end 2 by other similar articulations 7, the vertical strips 8 are still attached to the levers 3 and 4 and the horizontal strips 9 are attached to the end 2.

A typical assembly of this device 17 is shown in FIG. 2; the base 1 is fixed to a fixed structure of the support 11 and an optical component 12 such as a mirror is fixed to the end 2, for example by gluing. The levers 3 and 4 have articulation axes 13 and 14 belonging to the same plane and passing through the horizontal strips 9 that have an intersection point located slightly in front of the end 2 and that advantageously lies inside the optical component 12, and more precisely at a median depth in a vertical plane originating from the centre of gravity 16 of the component 12 or at least close to it; gravity forces applied to the device 17 due to the weight of the component 12 induce rotation of the levers 3 and 4, but produce a simple vertical movement of the component 12, without tipping, that would modify its shape. The limitation of the deformation of the component is an important effect of the invention.

In the remainder of this description, we will describe some statically determinate assemblies of the component 12 using a device like that (17) in FIGS. 1 and 2, but some general considerations will be introduced first. The component 12 will be assumed to be vertical.

A statically determinate assembly eliminates six degrees of freedom (three translations and three rotations) of the component 12 without any redundancy, by a series of judiciously chosen and positioned connecting elements to the support 11. These elements themselves must have flexible internal degrees of freedom, in order to prevent the assembly becoming statically indeterminate. The usual elements block movement of the component 12 in one, two or three principal translation directions (X, Y and Z). A “plane element” is a connection that blocks one translation direction, a “line element” is a connection that blocks two translation directions and a “point element” is a connection that blocks three translation directions. A statically determinate assembly is therefore usually obtained by combinations of one line element, one point element and one plane element, or three line elements. Combinations of six plane elements are equivalent to a combination of three line elements. If three elements are in the same plane (the back face of the component 12) and if a point element is in line with a line element, or if the three line elements all pass through a single point, changes in the distance between the elements for example due to thermal expansions, do not create any deformation of the component 12.

We will now give some example classifications of specific support devices among these elements. A ball joint allows three rotations and blocks three translations, and is therefore a point element. Putting two ball joints in series blocks a single translation and forms a plane element. A ball joint in series with a rotation axis forms a line element.

We will now consider elastic strips similar to the strips 8 and 9 already encountered. A short strip allows a single rotation. Two perpendicular short strips allow two rotations in series, and if the two bending axes are parallel to the back face of the component 12, the strips combined may be considered as a point element.

Another example of a support device 18 given in FIG. 3 comprises a strip 21 and a short wire 22 with an intermediate junction 23 between its two ends 19 and 20. The short wire 22 is equivalent to a ball joint allowing three rotations between the end 22 and the junction 23, and therefore it forms a point element. If the wire were longer, or if two short wires were available in series, a single translation (in line with the ends 20 and 22) would be blocked and the result would be a plane element. The device 18 in FIG. 3 composed of a strip 21 in series with a short wire 22, allows a single translation between the ends 20 and 22 (in the direction 24 perpendicular to the strip 21) and therefore forms a line element. Another line element 35 is shown in FIG. 4 and comprises, in sequence between ends 26 and 27, a horizontal strip 28, a vertical strip 29 and a horizontal strip 30, junctions 31 and 32 connecting the strips 28 and 29 and then the strips 28 and 30. It can be seen that this element allows translations along the vertical direction 33 between the ends 26 and 27, while translations allowed in the horizontal direction 34 are smaller and even negligible due to the short length of the strip 29.

Those skilled in the art could easily design other reconstitutions of point, line and plane elements based on the above information and possibilities of combinations between elementary connections. The device 17 described above may be considered to be a line element because the levers 3 and 4 both allow translations of the component 12 in the horizontal direction relative to the support 1, but block vertical translations despite the flexibility of the articulations 7.

FIG. 5 shows a first statically determinate assembly of the optical component 12. It is held in place by two devices 17 and a device 35 in accordance with FIG. 4, all fixed at its back face. The two devices 17 are placed at the top right and left corners, symmetrically about the central vertical line 36 of the component 12 (originating from the centre of gravity 16), at the same height and their levers 3 and extend in vertical planes. The element 35 is below the component 12, on the central line 36 and it is oriented in the manner shown in FIG. 4 with two of its strips (28 and 30) being horizontal and one (29) being vertical. Both of the elements 17 allow horizontal translations of the component 12 but block vertical translations, while the device 35 has the inverse effect of allowing vertical translations while blocking horizontal translations. Therefore, their combination blocks the three translations (including perpendicular to component 22). The scheme is shown in FIG. 6, in which the movements allowed by the devices 17 are symbolically represented as 37 and 38, and movements allowed by the element 35 are symbolically represented as 39. The movements 37 and 38 are in line with each other along a horizontal line 40, the movement 39 lies along a vertical line 36 that intersects the previous line forming a generally T shape. The statically determinate assembly is obtained respecting the criterion mentioned above of a connection with three convergent line elements because the devices 17 and 35 absorb complementary forces.

The final figures in the description diagrammatically show other possible embodiments. The assembly in FIG. 7 resembles the assembly in FIG. 6, except that the line elements allowing horizontal movements (in this case 41 and 42) are below the component 12 and the line element allowing vertical movements 43 is located at the top and it may be at the centre of the component 12 or at one of its corners, as is shown here. These are also devices 17 that allow horizontal movements 41 and 42 and a device 35 that allows the vertical movements 43; the support of component 12 remains statically determinate if the positions of the devices 17 and 35 vary, provided that the condition of coincidence of the movement lines 41, 42, 43 is satisfied.

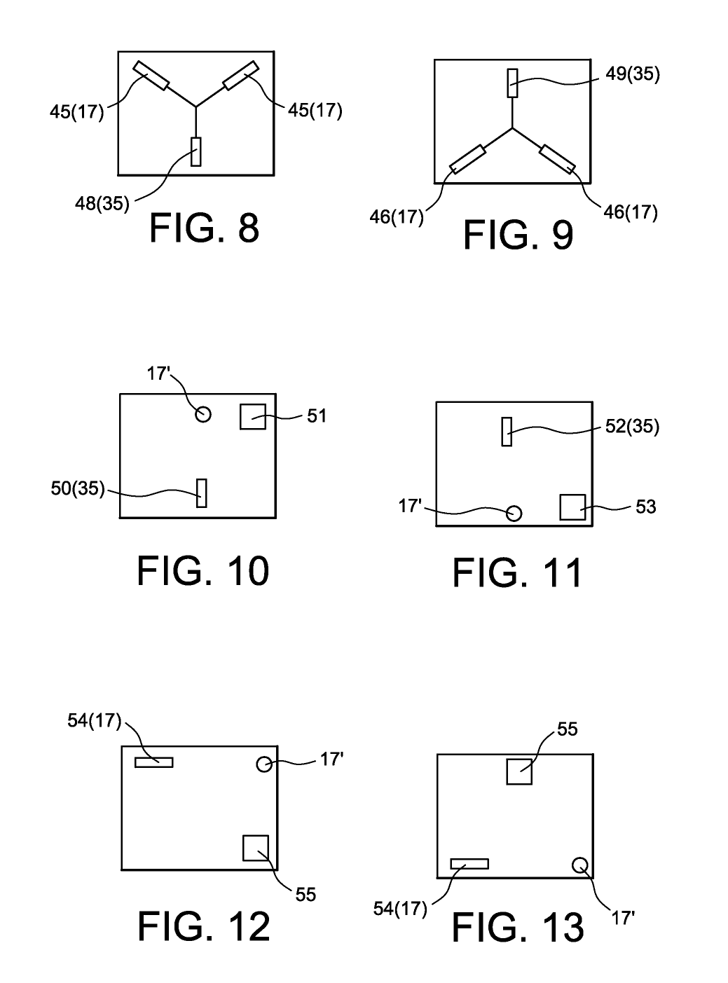

The assemblies in FIGS. 8 and 9 resemble the assemblies in FIGS. 6 and 7, but the movements (44, 45, 46 or 47) allowed by the devices 17 are oblique in this case, which can be achieved by arranging the planes in which the levers 3 and 4 are placed obliquely, unlike what has been proposed in the past. Devices 35 allowing vertical movements 48 and 49 are used once again. It is easy to respect convergence of the directions of movements 44, 45 and 48 or 46, 47 and 49.

Thus as mentioned, assemblies with a line element, a point element and a plane element are also possible and the invention can improve them. For example, devices conforming with the invention and similar to devices 17 will be used, in which the articulations 7 are simply replaced by short horizontal strips (like strips 9), therefore directly joining the levers 3 and 4 either to the principal portion 5 of the base 1, or to the end 2; these devices will be marked as reference 17′ and will correspond to point elements, in that they no longer allow horizontal translation between the component 12 and the fixed structure 11, and therefore block their three principal translations.

The assembly in FIG. 10 comprises one device 17′ at the top centre of the component 12, a device such as 35 associated with a line element with a vertical movement 50 at the bottom centre like the assemblies in FIGS. 6 and 8, and a device associated with a plane element 51 in another position, for example in a top corner. FIG. 11 shows an assembly symmetric about a line through the centre of the component 12, in other words with the device 17′ at the bottom centre, the device 35 at the top centre (still allowing a vertical movement 52) and a plane element 53 at a bottom corner. The assembly in FIG. 12 comprises a device 17 that allows a horizontal movement (as in FIGS. 6 and 7) 54 in a top corner, a device 17′ on the movement line 54 at the opposite top corner, and a plane element 55 at a bottom corner, for example at the side of device 17′. The device could also be placed elsewhere, as shown in FIG. 13 in which the devices 17 and 17′ in this case are placed on a line near the bottom of the component 12 and the plane element is located at the top of the component 12.

The devices 17′ have the same property as the devices 17 to support the self-weight of the component 12 without allowing it to tip due to the position of the intersection point 15 of the axes 13 and 14 at mid-depth of the component, such that assemblies with two line elements according to the invention could be replaced by a line element and a point element (according to the invention), also different from the previous assemblies in that the third element will be a plane type element.

1-8. (canceled)

9. Assembly comprising a support, a component (12) particularly an optical component and at least one supporting device (17) comprising a base (1), an end (2), two levers (3, 4) lying between the base (1) and the end (2) forming an angle and converging towards the end, the levers being articulated at the base and at the end so as to be free in rotation in a plane in which they both extend, the component being fixed to the end of the device and the base being fixed to the support, characterised in that, the component standing vertically, a point (15) at which the lever centre lines intersect is in a vertical plane extending at a median depth of the component and to which belongs the centre of gravity (16) of the component, a plane in which the levers of the device extend also being vertical.

10. Assembly comprising a support according to claim 9, characterised in that it comprises two of said supporting devices and in that, for each of the devices, the point (15) at which the lever centre lines intersect is in a vertical plane extending at a median depth of the component and to which belongs the centre of gravity (16) of the component, a vertical line (36) originating from the centre of gravity passing between said points at which the lever centre lines intersect.

11. Assembly according to claim 10, characterised in that said devices are placed symmetrically relative to said vertical line (36).

12. Assembly according to claim 9, characterised in that the assembly is statically determinate, the optical element being fixed to the support by three said devices, in which either each of the devices prevents translations in one direction, or one device prevents translation in one direction, one in two directions and the third prevents translation in three directions.

13. Assembly according to claim 12, characterised in that all three devices fixing the optical element to the support comprise levers articulated at a base (1) fixed in the support (11) and at an end (2) fixed to the component (12).

14. Assembly according to claim 9, characterised in that the levers are articulated at the base (1) and at one end (2) by elastic strips (8,9).

15. Assembly according to claim 9, characterised in that the levers are articulated at the base and at the end so as to be as free as possible in rotation perpendicular to said plane.

16. Assembly according to claim 14, characterised in that the levers are articulated at the base and at the end by pairs of elastic strips arranged in series along the levers, each of the pairs comprising a strip (8) oriented in said plane and a strip (9) perpendicular to said plane.

17. Assembly according to claim 15, characterised in that the levers are articulated at the base and at the end by pairs of elastic strips arranged in series along the levers, each of the pairs comprising a strip (8) oriented in said plane and a strip (9) perpendicular to said plane.
